(19) United States
(12) Patent Application Publication
(10) Pub. No.: US 2002/0057228 A1
(43) Pub. Date: May 16, 2002

(54) Wearable display having ergonomically positioned microdisplay

(76) Inventors: Sina Fateh, Sunnyvale, CA (US); James F. Flack, Los Alto Hills, CA (US)

Correspondence Address: OPPENHEIMER WOLFF & DONNELLY, P. O. BOX 10356, PALO ALTO, CA, 94303, US

(21) Appl. No.: 09/895,758

(22) Filed: Jun. 28, 2001

Related U.S. Application Data
(60) Provisional application No. 60/249,016, filed on Nov. 14, 2000.

(51) Int. Cl. G09G 5/00

(52) U.S. Cl. 345/7

(57) ABSTRACT

An ergonomically designed display that is preferably wearable. The display treats two-dimensional data as though it were three-dimensional, thus reducing the strain associated with display devices. This is combined with positioning the display below the horizon of vision and angling the displays so that they are perpendicular with the line of vision of a user.

This application claims priority, under 35 U.S.C. § 119(e), of Fateh, et al.'s U.S. provisional application No. 60/249,016 filed, Nov. 14, 2000, which is incorporated herein by reference.

### BACKGROUND OF THE INVENTION

This invention focuses on three aspects of integrating visual display devices. These are convergence, accommodation and horizon.

Convergence is the term that describes how the eye naturally turns inward when it focuses on an object that is closer than infinity. The closer the object, the more the eye turns inward. For example, a natural reading distance for a person is 18 inches, in which case the angle of convergence of each eye is 3.9725 degrees inward from parallel. Prior art display devices do not allow for convergence, and attempt to have the eye focus straightforward, which is at a point infinitely far away.

Accommodation is what the eye does to bring a picture into focus. Display devices currently in use are designed to present their images at a relatively near focal distance that is defined by their optical design. To see the image, the eyes must accommodate (focus) at that near distance. Physiologically, when the eye muscles contract around the lens to focus nearby objects, it is natural for the other eye muscles to act in concert causing the two eyes to converge at approximately the same focal distance. If the optical design of the display device, however, presents the images so the eyes look straight ahead and parallel, the result is a conflict between the natural eye muscle movement for accommodation and the natural eye muscle movement for convergence. When the eye muscles have to fight this impulse to converge, this conflicting impulse is responsible for much of the eyestrain, headaches and nausea experienced in using these devices.

Wearable display devices that show three-dimensional data can avoid this problem by using computer software can process information about a three-dimensional object from two eye-points and these images are displayed simultaneously. Because the images are slightly different due to the varying perspective from the two eye-points, called parallax, the user's brain synthesizes this visual information into a stereoscopic mental image of the three dimensional object. Although wearable display devices are suited for the display of stereoscopic three-dimensional images, their design is not well suited to the display of most computer information, since typically computer information is not three-dimensional but, rather, two-dimensional. The computer software does not treat two-dimensional data like an object with two different eye-points but as identical content, and presents the same image to each of the two displays.

A further problem that exacerbates this dilemma is that images in current optical displays tend to be positioned at or above the horizontal field of view relative to the head. That is, the user has to look either straightforward, or upwards. This is unnatural as the human eye is designed to look at nearby objects/images when they are below the horizon. The human eye even converges and accommodates more naturally and with less strain when looking downwards instead of straight ahead or upward. So an image set below the horizontal field of view, which has a convergence angle for the two eye's images set to coincide with the distance that the images are in focus, will allow the eye to converge and focus naturally, and not receive conflicting accommodation signals from the brain. Unfortunately, most wearable display products currently on the market force a user to either look at the horizon or upwards.

FIG. 1 shows a pair of eyes 10, and their respective lines of sight 12 when focused at a distant image 14. When eyes 10 are looking at a distant image, the line of sight for each eye 12 is essentially parallel to one another. In truth, an object would have to be an infinitely large distance away in order for the line of sight of each eye to be completely parallel, but in practice the line of sight of a person's eyes are close to being parallel when focused on a point over 5 feet away.

FIG. 2 shows a pair of eyes 10, focusing on an object which is rather near 16, in this case a book. Here, the line of sight of each eye 12 converge with each other, and are far from being parallel. In the case of near objects, each eye receives a slightly different picture, and the brain merges them into one image.

This phenomenon has been taken into account when making displays for three-dimensional data. However, when displaying two-dimensional data, the prior art in a wearable display is to show the same image to each eye, in the same physical position for each eye. FIG. 3 shows a pair of eyes 10, each looking at a viewer 20 of a wearable display (the display itself is not shown but would resemble a type of goggles or glasses). The center point of each viewer 22 is positioned such that the line of sight for each eye 12 is parallel in regards to the other. The two dimensional image 24 is brought into a virtual focal point 26 approximately 18-32 inches from the eyes 10. As can be seen in FIG. 3, the virtual image 24 is created in duplicate. While the brain is normally accustomed to merging the images of each eye, the fact that line of sight of each eye 12 is still in parallel to one another creates a conflict of signals to the brain. This conflict is then responsible to the myriad of side effects mentioned earlier. One solution that the prior art has attempted in order to reduce these side effects is to bring the virtual focus to a point of fifty inches or greater from the reader, thereby attempting to match the induced parallel line of sight to what would normally be the line of sight at that distance. This, however, has the uncomfortable side effect of having the sensation of your reading material being greater than 50 inches away, rather than at a more comfortable 18-32 inches.

Therefore, a major problem with using wearable displays for conventional computer information is that the images presented in each eye are identical and they are typically presented in the center of their respective display device. This means that the user's two eyes are both looking straight ahead as if the object being displayed was located at the horizon. Physiologically, when the user's eyes are parallel, the eye muscles that control focusing the lens are relaxed to bring objects at a distance, such as on the horizon, into focus. However, if the optics of the wearable display bring the information into focus at a closer distance, as is typical of wearable display designs, then a conflict is created for the user's natural physiology. Use of display devices in these orientations cause eyestrain, headaches and nausea in users. What is needed is a display device that reduces or eliminates these side effects.

### SUMMARY OF THE INVENTION

The current invention seeks to reduce or eliminate the side effects of display devices, such as eyestrain, headaches and nausea, by positioning the display devices in ways that are more natural to the human visual process. One aspect of the novelty of the current invention is in treating two-dimensional data as though it were three-dimensional data, and positioning the wearable display accordingly.

In one embodiment of the present invention, for each eye there is a display device that shows two-dimensional data. In this embodiment, each display device is moved inward relative to each eye. In a refinement of this embodiment, the display device is angled so that the line of the eye is perpendicular to the plane in which the two-dimensional data is displayed.

A further refinement of this invention is having the angle adjustable within the range of natural convergence and accommodation for the human eye when looking at typical computer generated display information. Optimally this range will be between 18 and 32 inches.

In a preferred embodiment of the invention, the display is located below the horizon of vision (i.e. horizontal with respect to the head).

In a further preferred embodiment, the display is wearable.

In one embodiment the display is moved inward mechanically. In an alternate embodiment the display is moved inward digitally. A further refinement of the present invention combines digitally altering two-dimensional data with mechanically adjusting the display.

### BRIEF DESCRIPTION OF THE DRAWINGS

FIGS. 1 and 2 are pictorial illustrations showing how the line of sight of an eye goes from being parallel when looking at a distance, to converging when looking at a nearer object.

FIG. 3 is a pictorial illustration showing the prior art, how a two dimensional binocular display is focused with each eye looking in parallel.

FIG. 4 is a pictorial illustration showing an aspect of the current invention whereby the binocular two-dimensional display allows the line of sight of the eyes to converge at an artificial point represented by the virtual image.

FIGS. 5 and 6 are pictorial illustrations showing mathematically the distance and angles for calculating the adjustments needed to make the aspect of the invention shown in FIG. 4.

FIG. 7 shows one example of how an image is move inwards with respect to each eye.

FIG. 8 shows how correcting the convergence problem leads to a minor problem of the line of sight no longer hitting the eye at the perpendicular.

FIG. 9 shows a further adjustment of tilting the lens perpendicular to the field of vision.

FIG. 10 shows how the eye naturally looks inwards when looking below the horizon of vision.

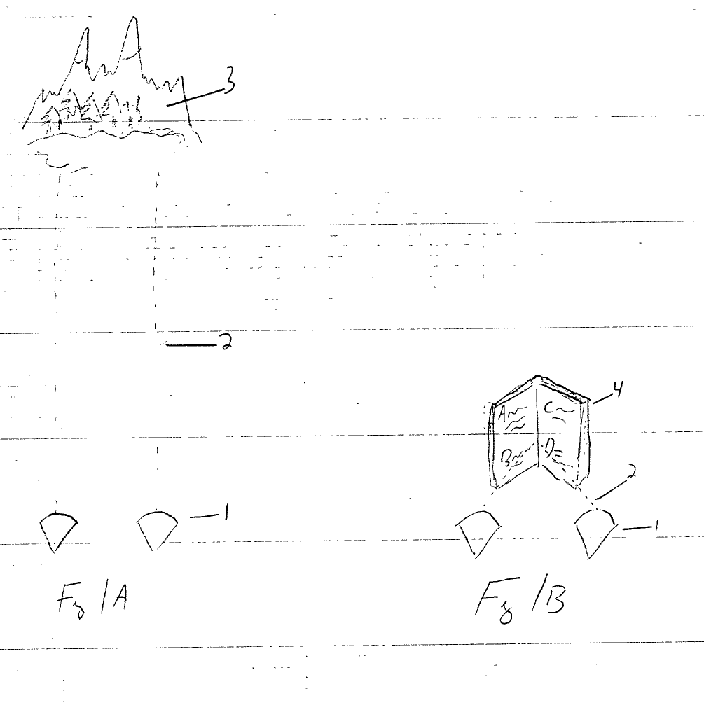

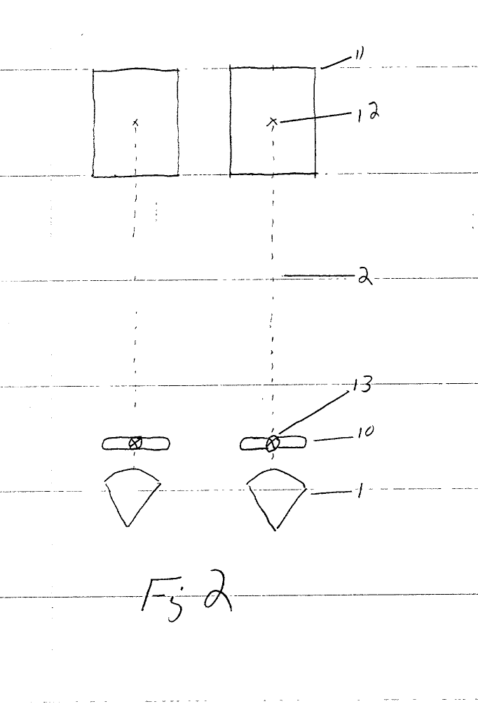

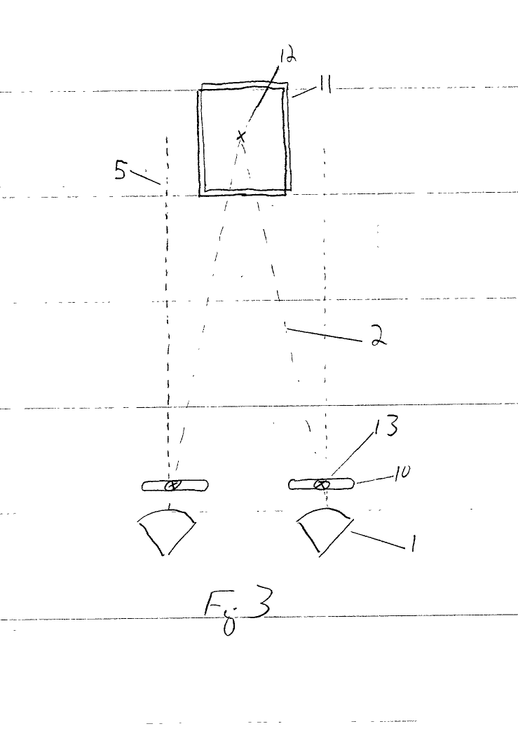

### DETAILED DESCRIPTION OF THE PREFERRED EMBODIMENTS

As mentioned earlier this invention seeks to reduce or eliminate the side effects of display devices, such as eyestrain, headaches and nausea, by positioning the display devices in ways that are more natural to the human visual process. One aspect of the novelty of the current invention is in treating two-dimensional data as though it were three-dimensional data, and positioning the wearable display accordingly. This is done by focusing on properly integrating the aspects of convergence, accommodation and horizon into visual display devices

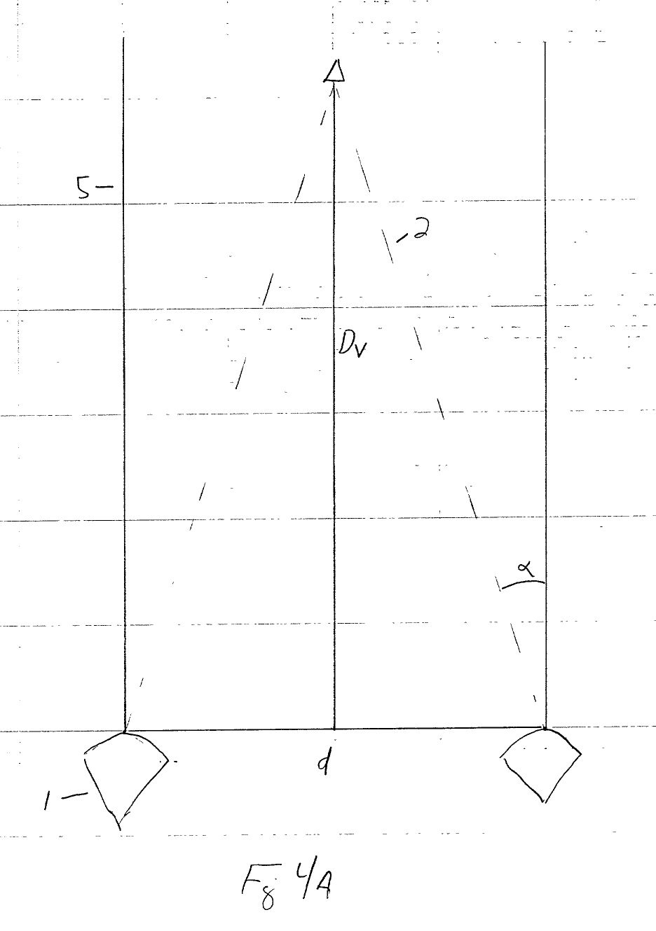

FIG. 4 shows one embodiment of the current invention, which helps to correct the problem in the prior art. By treating two-dimensional data as though it were three-dimensional data, the viewers 20 have their center points 22 moved inward. The line of sight 12 for each eye then becomes intersected as seen in FIG. 4, rather than parallel (the parallel is still shown as element 30 for clarity). The virtual image 24 for each eye therefore “exits” in the same, or almost the same, space.

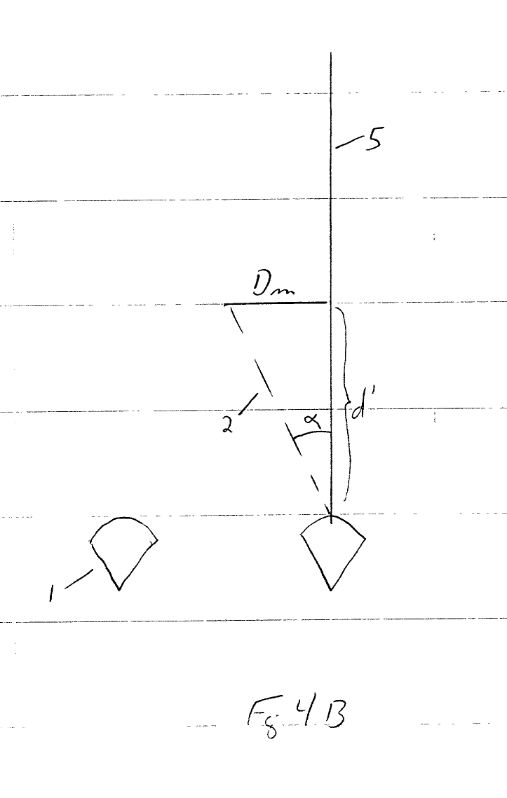

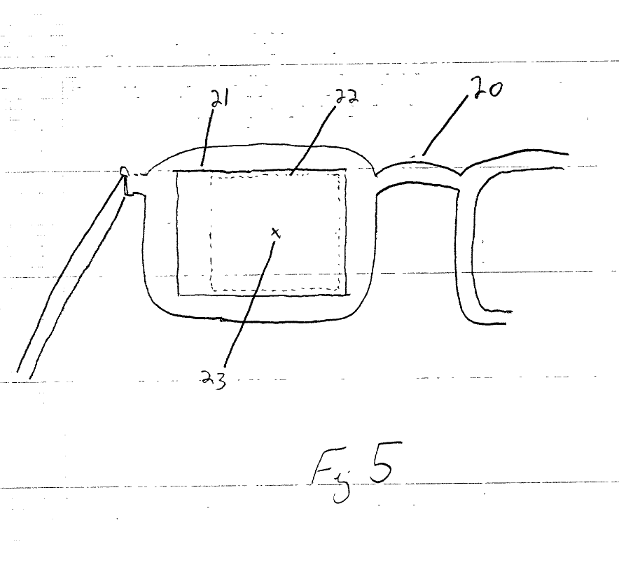

FIGS. 5 and 6 mathematically represents the aspect of the invention shown in FIG. 4. The distance between eyes, d, which is typically 6 cm or 2.4 inches, and the distance to the virtual image Dv, which can be any positive number but is preferably between 18 and 32 inches, determines the inwards deviation angle the line of sight has from the parallel.

can easily be determined by the formula:

=tan⁻¹(^{d/2/}Dv)

FIG. 6 then mathematically shows the distance Dm the viewer, which is measured from the center point, is moved inwards. This is determined by and how far the image is from the eye itself d′. Dm can easily be determined by the formula:

Dm=d′ tan

The distance Dm can be preset for most users, since the average distance between people's eyes is relatively constant, and a comfortable virtual reading distance can be predetermined. However, user preference, and being able to accommodate varying virtual distances will likely also be important, so having Dm adjustable by the user or controlling program is a preferred embodiment of this aspect of the invention.

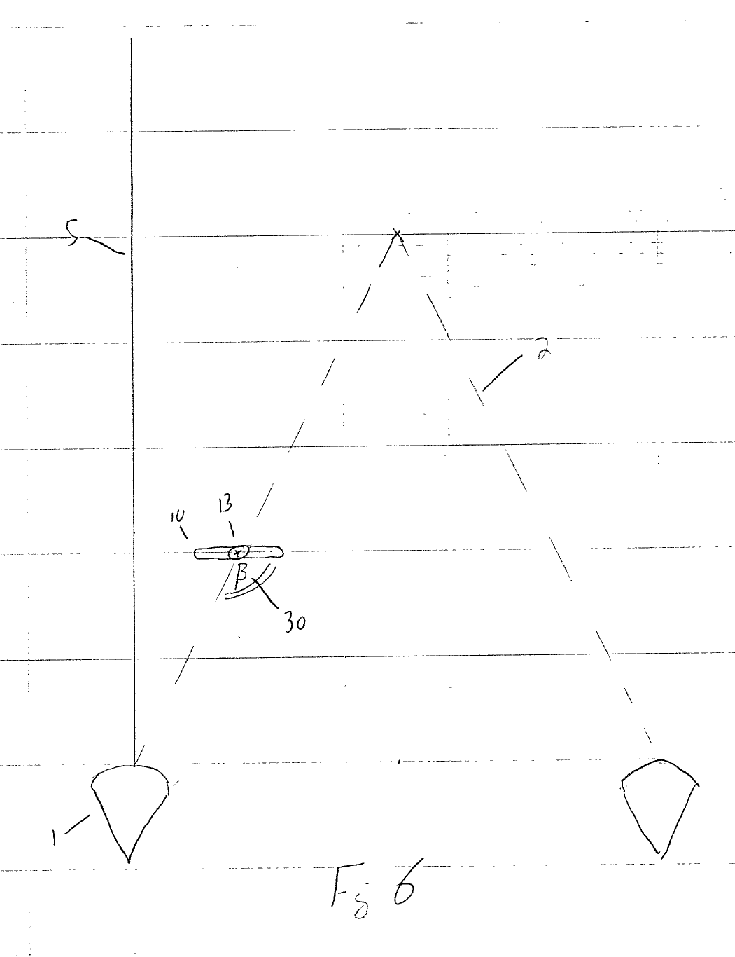

Adjusting Dm can be done by a variety of different methods. The two most favored methods are mechanically and digitally. FIG. 7 shows one example how Dm can be adjusted digitally. A set of virtual display glasses 40 contains an area within which a digital image can be created 42 the digital image itself 44 is created somewhere within this area and the center point 46 would be moved a distance of Dm inwards from the parallel (not shown). Essentially, the whole image is redrawn Dm distance inwards.

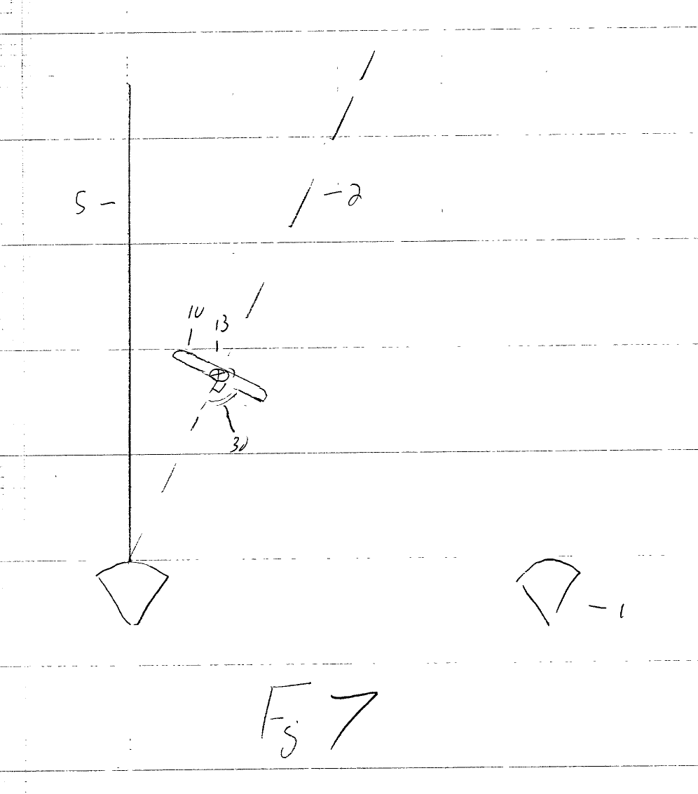

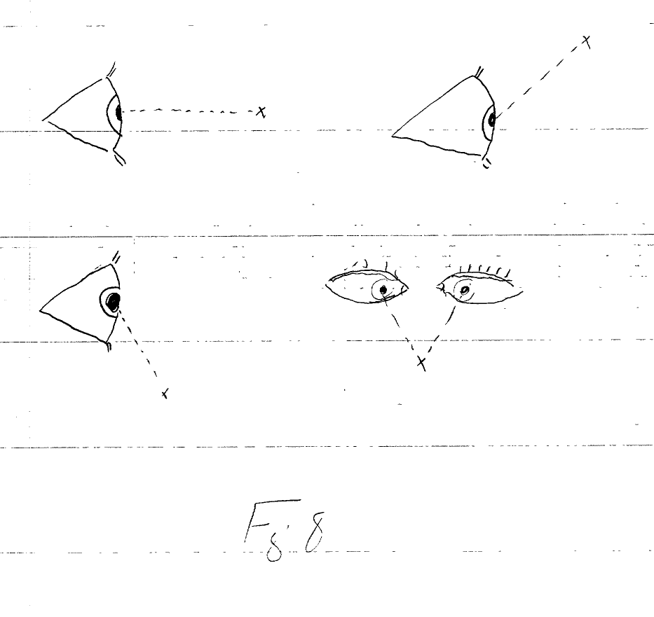

One further thing that can be addressed by this aspect of the invention is that the eye is no longer looking at the viewer perpendicularly. FIG. 8 shows how the eye 10 looking at the center point of the viewer 22 is at an angle 50 greater than 90° (distances and scale are, of course, overstated). This angle, is optimally brought back to 90° by angling the viewer. FIG. 9 shows an exaggerated example of how this is accomplished.

Yet another aspect of this invention is to place the center point of the virtual image below the horizon of vision (also referred to as the horizontal). When looking straight ahead or up, the eyes tend to be in a more relaxed state when looking parallel to one another. Yet when looking downwards, below the horizontal, the line of sight of the eyes naturally converge. By placing the viewers below the horizontal, the greater tendency of the eye to focus inwards is being taken advantage of. The virtual imager can therefore be worn for even longer without causing such side effects as eyestrain. Figure shows how the eye naturally focuses inward when looking down.

The invention is preferably designed to be used with a duel display, one for each eye. However, due to physical limitations or user preference, a monocular display can take the same advantage of the Dm adjustment, as well as the inward tilt, and the below the horizon placement of the viewer. Also, when a binocular display device is used, preferably the Dm and inwards tilt compensation is performed equally on both displays, but this need not be the case.

In the most preferred embodiment the display is wearable.

What is claimed is:

1. An optical display device having at least one optical display in a position of natural convergence for a human eye when said display device is displaying two-dimensional data.

2. The optical display device of claim 1, wherein said at least one optical display is located below the horizon of vision.

3. The optical display device of claim 1, wherein said position is adjustable within a range of said natural convergence of a human eye.

4. The optical display device of claim 1, wherein said position of natural convergence for a human eye is a virtual point between 28 and 32 inches in front of a user of said optical display device.

5. The optical display device of claim 1, wherein three-dimensional data is also displayed on said at least one wearable display device.

6. The optical display device of claim 1, wherein said optical display device is wearable.

7. A method of making an optical display device, comprising:
positioning at least one optical display at an angle of natural convergence for a human eye when said optical display device is displaying two-dimensional data.

8. The method of making an optical display device of claim 7, wherein said at least one optical display is located below the horizon of vision.

9. The method of making an optical display device of claim 7, wherein said angle is adjustable within said range of natural convergence of a human eye.

10. The method of making an optical display device of claim 7, wherein said position of natural convergence for a human eye is an artificial point between 28 and 32 inches in front of a user of said optical display.

11. The method of making an optical display device of claim 7, wherein three-dimensional data is also displayed on said at least one wearable display device.

12. The method of making an optical display device of claim 7, wherein said optical display device is wearable.

13. An optical display device having at least one optical display is in a position of natural convergence and accommodation for a human eye, wherein said position is inward from parallel position, whereby a user looks inward when focusing on an image on said at least one optical display.

14. The optical display device of claim 13, wherein said optical display is angled so that it is perpendicular to the line of vision of said user for each eye used.

15. The optical display device of claim 13 wherein said optical display is below the horizon of vision.

16. The optical display device of claim 14, wherein said optical display is below the horizon of vision.

17. The optical display device of claim 15 wherein said device is wearable.

18. An optical display device for at least one eye displaying two or three-dimensional data, said data being displayed at in inward position relative to a user's eye, said inward position corresponding to a degree of natural convergence as if said data were at a real rather than virtual distance.

19. The optical display device of claim 17, wherein said optical display is angled so that it is perpendicular to the line of vision of said user for each eye used.

20. The optical display device of claim 17, wherein said optical display is below the horizon of vision.

21. The optical display device of claim 18, wherein said optical display is below the horizon of vision.

22. The optical display device of claim 19 wherein said device is wearable.

23. The optical display device of claim 17 wherein said inward position is adjustable by said user.
